(19) United States
(12) Patent Application Publication
(10) Pub. No.: US 2024/0011667 A1
(43) Pub. Date: Jan. 11, 2024

(54) Electric Heating Assembly and Method of Manufacturing the Same

(71) Applicant: Eberspächer catem GmbH & Co. KG, Herxheim (DE)

(72) Inventors: Michael Niederer, Kapellen-Drusweiler (DE); Ulrich Lehr, Haßloch (DE); Müge Pilavtepe-Christ, Karlsruhe (DE); Rüdiger Freitag, Landau (DE); Ahmad Asafi, Karslruhe (DE)

(21) Appl. No.: 18/218,321

(22) Filed: Jul. 5, 2023

(30) Foreign Application Priority Data
Jul. 7, 2022 (DE) 10 2022 116 979.0

(51) Int. Cl. F24H 3/04; H05B 3/06; B21D 22/02

(52) U.S. Cl. CPC F24H 3/0429; F24H 3/0476; F24H 3/0441; H05B 3/06; B21D 22/022; F24H 2250/04; H05B 2203/017

(57) ABSTRACT

An electric heating assembly of an electric heating device includes a metal housing which forms a pocket in which at least one PTC element, contact sheets abutting surfaces of the PTC element and insulating layers which are arranged between the contact sheets and inner surfaces of the pocket. The contact sheets each have contact projections which project in the direction of one of the contact surfaces of the PTC element and are surrounded by an adhesive which connects the contact sheet to the PTC element. In order to improve heat extraction from the electrical contact of the PTC element, front end regions of the contact projections abutting against the PTC element are plastically deformed against the surface of the PTC element. Also disclosed is a method of making a heating device.

### BACKGROUND OF THE INVENTION

### 1. Field of the Invention

The present invention relates to an electric heating assembly of an electric heating device. In particular, the present invention relates to an electric heating assembly of an electric heating device for a motor vehicle. The invention also relates to a method for manufacturing such an electric heating assembly.

### 2. Background of the Invention

The electric heating assembly for a motor vehicle, in which the electric heating assembly according to the invention can be installed, can correspond to a heating assembly according to EP 1 872 986 A1. In this prior art, an electric heating assembly with at least one PTC element, strip conductors in the form of contact sheets abutting against contact surfaces of the PTC element in an electrically conductive manner, and insulating layers abutting against the strip conductors on the outside is inserted into a pocket which projects into a circulation chamber as a heating fin. The electric heating device is used to heat a liquid medium, in particular water.

From EP 1 768 457 A1, an electric heating device for a motor vehicle is known, in which at least one PTC element is provided between contact sheets that are electrically conductive on both sides. Insulating layers are located on the outside of the strip conductors. Corrugated fin layers are abutted against these insulating layers and are accommodated in a housing made of plastic, which configures inlet and outlet openings for the passage of air to be heated. Such an electric heating device may also be an electric heating device in which the electric heating assembly of the present invention is used.

In the aforementioned prior art documents, the strip conductor is applied in an electrically contacting manner against the PTC element by an externally acting clamping force. Thus, the power current required to heat the PTC element can be introduced into the PTC element with low contact resistance. For this purpose, the PTC element usually has a metallization on its surface that is electrically conductively connected to the surface of the strip conductor. In this prior art, the sheet metal surface of the strip conductor is in direct contact with a contacting surface formed by the PTC element.

PTC elements are semiconductor components made of ceramics. The surface of the PTC elements is usually rough. Thus, contacting actually takes place via a plurality of contact surfaces which are formed by the roughness peaks of the metallization of the PTC element and which are applied in an electrically conductive manner to a sheet surface of the strip conductor, which is arranged parallel to the surface of the PTC element when viewed macroscopically.

In addition to good mechanical coupling between the strip conductor and the PTC element, attention must be paid to good heat extraction when manufacturing heat-generating elements with strip conductors attached to the PTC element. The strip conductor usually abuts a main side surface of the PTC element. This main side surface is the largest side surface of the usually cuboid-shaped body, in this case the PTC element. The other surfaces, which usually connect these main side surfaces at right angles to the main side surfaces, are referred to below as end side surfaces. They have a much smaller width than the main side surfaces. The width of the end sides is usually smaller than the width of the main side surfaces by at least a factor of 3. The width of the end side surfaces determines the height of the PTC element. In any case, the strip conductors usually abut against the main side surfaces of the PTC element that extract the heat, so that the heat must be extracted through the strip conductor. These specifications also apply to a typical configuration of the PTC element of the heat-generating element according to the invention.

Sometimes the strip conductors are additionally or alternatively connected to the PTC element by means of an adhesive. For example, DE 10 2019 220 589 A1 describes an electric heating assembly with contact surfaces from which contact projections integrally formed on the contact sheets, produced by deforming, protrude. These contact projections are applied directly against the surface of the PTC element in an electrically conductive manner. A free space defined by the contact projections between a flat sheet surface of the contact sheets, from which the contact projections protrude, and the PTC element is filled with a good heat-conducting electrically insulating adhesive. This results in defined contact points for current introduction.

From EP 2 053 902 A1, a method for manufacturing an electric heating assembly is known, in which a PTC element with a contact sheet and an insulation in the form of a plastic film is inserted into a flat tube within a positioning frame and the flat tube is formed so that opposing inner surfaces of the flat tube are pressed against the plastic film on the one hand and against the PTC element on the other hand, so that the latter abuts directly against the flat tube on one side and against the contact sheet on the other side. Edge areas of the flat tube are deformed which are offset inwards relative to the heat-emitting contact surface of the flat tube and lie outside the heat-emitting surfaces. This prior art is based on the idea that the inner surfaces of the flat tube are pressed as flat as possible against the plastic film or the PTC element so that good heat extraction is achieved.

A similar solution is known from DE 103 60 159 A1. In this prior art, only the opposing main side surfaces of a flat tube, which is at first essentially a rectangular profile, are formed and bent toward each other. The electric heating assembly thus produced has no clearly defined external heat-emitting surfaces.

The application of pressure for grouting the housing is not always uncritical. Considerable mechanical stresses can damage the PTC element as well as any insulating layer made of a ceramic.

In this respect, the proposal according to DE 10 2019 205 848 A1 provides a solution, in which the inner surfaces of the housing are abutted against the ceramic plates on the outside by preforming curved edges of the housing outside the base area of the PTC element and the ceramic plates provided as an insulating layer.

### SUMMARY

The present invention aims to specify an electric heating assembly which meets the above requirements of a good mechanical connection between the contact sheets and the PTC element on the one hand and a good heat extraction from the PTC element on the other hand in an improved manner.

In a generally known manner from DE 10 2019 220 589 A1 and its U.S. counterpart, US20210204365, the subject matter of each of which is hereby incorporated by reference, the electric heating assembly has at least one PTC element and contact sheets abutting usually opposite main side surfaces of the PTC element. These contact sheets are connected to the PTC element via an adhesive. The contact sheets have contact projections. These contact projections each form contact surfaces which are applied to the surface of the PTC element in an electrically conductive manner. The contact projections protrude over a regularly flat surface of the contact sheets, referred to below as the sheet surface, which extends parallel to the surface of the usually cuboid-shaped PTC element. The contact projections thus provide a free space between the surface of the PTC element and the sheet surface of the contact sheets, in which the adhesive is accommodated.

The configuration of the contact projections allows the free space to be configured with a defined shape. This free space contains the adhesive. Usually, the free space is completely or at least almost completely filled with the adhesive, so that the adhesive is provided in the entire heat conduction path. In this context, it is assumed that the contact sheets are each provided with at least the size of the surface of the PTC element and cover it completely.

The particularity of the present invention is that front end regions of the contact projections are deformed as a result of the deformation of a metal housing which accommodates the PTC element, the contact sheets and the insulating layers abutted externally thereto and protects this layered structure from the fluid to be heated. The metal housing is deformed so that the inner surfaces of the metal housing are applied in a well heat-conducting manner against the outer surfaces of the insulating layer. Within the scope of this deformation of the metal housing, the contact projections are also deformed. This results in an electric heating assembly in which the contact projections have boundary surfaces abutting the PTC element which are plastically deformed, namely by compression of the main side surfaces of the housing and as a result of the compression of these main side surfaces.

The front end regions of the contact projections may be plastically deformed by displacing the adhesive against the surface of the PTC element. In the case of the electric heating assembly, the adhesive is thus may be pressed out at the edges over the insulating layer or the contact sheet, whereby the inclusion of cavities or air spaces can be avoided with greater certainty. The excess adhesive can also fill any free space between a frame-shaped housing, which accommodates the at least one PTC element, and the PTC element and/or the contact sheets. The parts of the heating cell subjected to the power current of the electric heating assembly are thus circumferentially sealed by the adhesive and accommodated within the housing with greater electrical safety.

The contact sheet forms a usually closed sheet surface. The contact sheet can be made of aluminum or copper. The contact sheet can have a coating of an electrically high-quality material such as silver or tin-silver. The contact projections, which usually protrude from the sheet surface as convexly curved elevations, are usually formed by bending. The contact projections may be distributed as uniformly as possible over the entire surface of the PTC element.

The adhesive can be any heat-resistant adhesive. In particular, the adhesive is a 1-component silicone adhesive that crosslinks at about 150°. It may be provided with good heat-conducting particles. The maximum particle size of these particles typically should not exceed 90 μm, more typically 70 μm. The adhesive may be an electrically non-conductive adhesive. The electrical contact may be made exclusively via the contact surface of the contact projections. Thus, the adhesive has an adhesion-promoting and heat-conducting function. For the best possible heat conduction to the outside of the heat-generating element through the adhesive, the filler content of the particles with good heat-conducting properties is typically more than 90 Vol-%, more typically more than 94 Vol-%.

With regard to high-voltage applications, an insulating layer is provided at least on the outside of one of the contact sheets. This insulating layer usually covers the contact sheets completely. Both contact sheets are provided with a corresponding insulating layer on their outside. The insulating layer can be formed by a ceramic plate, for example an aluminum oxide plate. The insulating layer can also have a multilayer structure, for example a combination of a plastic film and a ceramic plate, as known for example from EP 1 768 457 A1. In this case, the multiple layers of the insulating layer are regularly joined into a unit by calendering or other joining techniques.

Usually, the insulating layer is bonded to the associated contact sheet. Here, too, attention should be paid to a thin adhesive layer to ensure good heat extraction.

In the method according to the invention for the manufacture of a heat-generating element, the contact sheets are provided with an initially flat sheet surface and are processed by forming to form contact projections protruding from the flat sheet surface. Subsequently, an adhesive is applied to the contact sheets without covering the end regions of the contact projections with the adhesive. The adhesive may be applied to both surfaces of the contact sheets before the contact sheets are abutted against the PTC element on opposite sides with the adhesive enclosed. With the insulating layers abutted on the outside against the strip conductors, insertion is carried out into the pocket of the metal housing. The metal housing is then deformed so that the inner surfaces of the metal housing are pressed in the direction of the PTC element. The deformation is a plastic deformation. During this plastic deformation, end regions of the contact projections abutting against the PTC element are plastically deformed. On the one hand, this plastic deformation allows the contact sheets as a whole to approach the PTC element further. The free space between the flat sheet surface and the PTC element is reduced and thus the heat conduction path. The plastic deformation also results in intimate electrical contact between the contact projections and the PTC element, namely the metallization provided thereon. The rough surface of the PTC element presses into the contact projections under plastic deformation of the sheet material of the contact sheets.

The adhesive may be applied to the side of the strip conductor provided with the contact projections, usually by screen printing, with a thickness greater than the height of the contact projections above the flat sheet surface. Thus, prior to joining, the initially undeformed end regions of the contact projections lie below a plane formed by the surface of the adhesive. In a cross-sectional view through the strip conductor before joining, the adhesive on one side and the sheet surface on the other side form the outer surface. The contact protrusions end below the plane formed by the adhesive, but are exposed in recesses within the adhesive layer.

### BRIEF DESCRIPTION OF THE DRAWINGS

Further details and advantages of the present invention will be apparent from the following description of embodiments in conjunction with the drawing. Therein:

FIG. 1 shows a perspective exploded view of an embodiment of a heat-generating element;

FIG. 2 shows a perspective top view of the embodiment according to FIG. 1 after joining the heating cell and before insertion into the metal housing;

FIG. 3 shows a cross-sectional view of the embodiment in the context of assembly;

FIG. 4 shows a cross-sectional view according to FIG. 3 at a later stage of assembly;

FIG. 5 shows a cross-sectional view according to FIG. 4 at a later stage of assembly;

FIG. 6A shows a top view of the contact sheet of the embodiment;

FIG. 6B shows a highly magnified cross-sectional view along line A-A as shown in FIG. 6A, with the contact projection shown here lying behind the line of intersection;

FIG. 7 shows a highly magnified cross-sectional view through layers of the heating cell before joining the PTC element;

FIG. 8 shows a cross-sectional view according to FIG. 7 after joining the PTC element;

FIG. 9 shows a schematic view of a forming tool;

FIG. 10 shows a cross-sectional view according to FIGS. 6 and 7 after forming the metal housing;

FIG. 11 shows a perspective side view of an embodiment of a PTC heating assembly, and

FIGS. 12A-12I show perspective top views of parts of the electric heating device to illustrate the assembly sequence.

### DETAILED DESCRIPTION

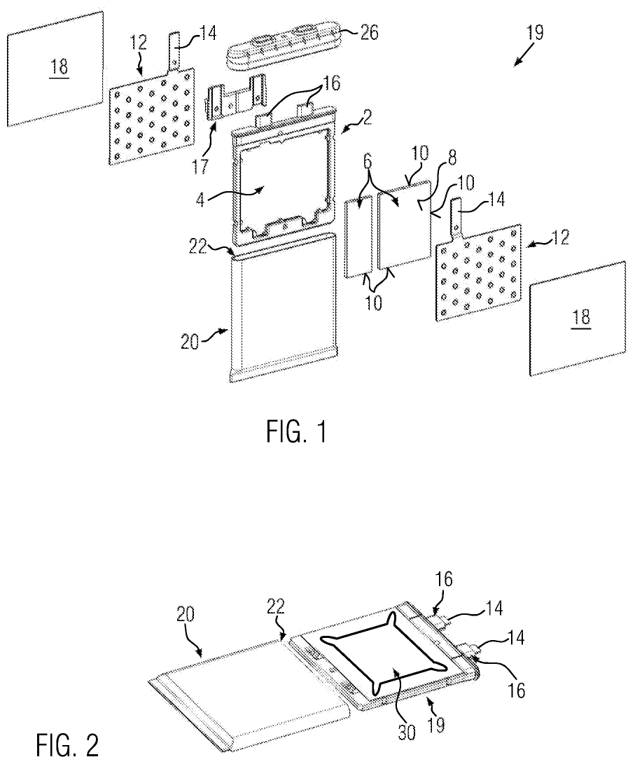

The embodiment according to FIG. 1 shows a housing 2 made of plastic, which is configured to be frame-shaped and forms an accommodation space 4 for accommodating PTC elements 6. The two PTC elements 6 are each configured to be cuboid-shaped and have opposing main side surfaces 8 which quite predominantly dissipate the heat generated by the PTC element 6 to the outside and which are connected to one another by respective circumferential end surfaces 10. Opposite the surface 8, strip conductors are shown in the form of contact sheets 12, each of which has a terminal lug 14 formed from the sheet material by punching and bending. Corresponding to these terminal lugs 14, connecting pieces 16 are provided on the housing 2, which accommodate the respective terminal lugs 14, so that the free end of the terminal lugs 14 protrudes beyond the housing 2. These free ends of the terminal lug 14 serve to energize the PTC elements 6 inside the housing 2. After insertion of the terminal lugs 14, the connecting pieces 16 are covered with a cover 17, which is fastened to the housing by means of hot-crimping pins that protrude from the housing 2 and each penetrate a bore of the cover.

Reference sign 18 shows insulating layers in the form of aluminum oxide plates the base area of which (excluding the terminal lugs 14) is larger than the base area of the contact sheets 12 or of the accommodation space 4 and which at least partially cover the frame-shaped housing 2 in the joined state. The accommodation space 4 formed by the housing 2 is completely covered by the aluminum oxide plates 18, at any rate in a top view of these. The contact sheets 12 are located inside the accommodation space 4, however not the terminal lugs 14. Spars of the frame-shaped housing 2 surrounding the accommodation space 4 have a smaller thickness than the PTC elements 6 together with the contact sheets 12 abutting them. The previously described component parts form a heating cell characterized by reference sign 19.

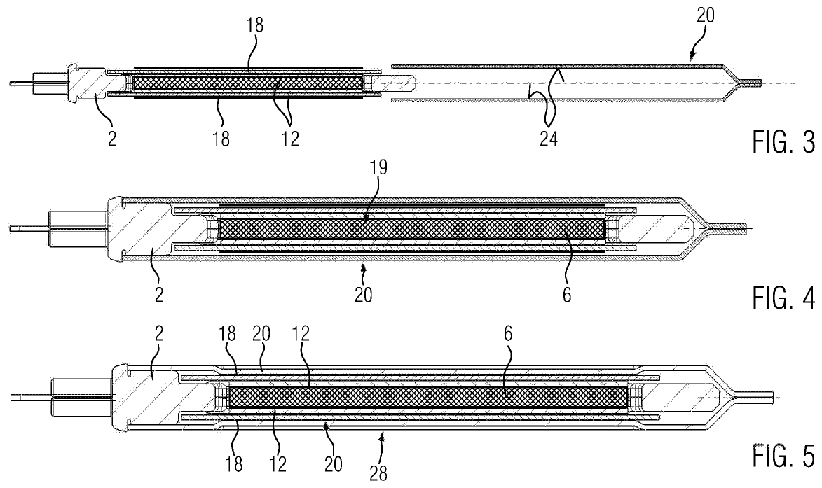

Reference sign 20 characterizes a metal housing made of aluminum, which is manufactured by means of extrusion and forms a pocket 22 closed on the lower side, which forms opposing inner surfaces 24 in its interior (cf. FIG. 3). After the metal housing 20 has been formed, a sealing collar 26 made of a soft-elastic plastic is drawn over the end of the metal housing 20 in order to fit the electric heating assembly 28 shown in FIG. 5 in a sealing manner into a receiving pocket of a partition wall described, for example, in DE 10 2016 224 296 A1. The metal housing 20 accommodates the heating cell 19 and protects it from the medium to be heated.

FIG. 2 illustrates the heating cell 19 before it is inserted into the metal housing 20. Reference sign 30 characterizes an adhesive pattern which is applied to the outside of the aluminum oxide plate 18. This adhesive pattern 30 has a substantially rectangular base area 32 and tip sections 34 extending from the corners of this rectangular base area 32 (cf. also FIG. 12I). The adhesive forming this adhesive pattern 30 is characterized by reference sign 36. The tip sections 34 basically extend along a diagonal through the rectangular base area 32 from the respective corners of the base area 32. The adhesive pattern 30 has a rectangular shell surface defined by the free ends of the tip sections, the size of which corresponds approximately to the size of the main side surface 8 of the PTC element 6 and substantially covers this main side surface 8.

In the following, it is described with reference to FIGS. 1 to 5 and 12A up to the manufacture of the electric heating assembly 28.

First, the components shown in FIG. 1 are provided. The housing 2 is manufactured by injection molding of plastic. The metal housing 20 is manufactured from aluminum by impact extrusion. During impact extrusion, the metal housing 20 is configured as a pocket 22 closed on the lower side. The distance between the inner surfaces 24 is greater than the thickness of the heating cell 19.

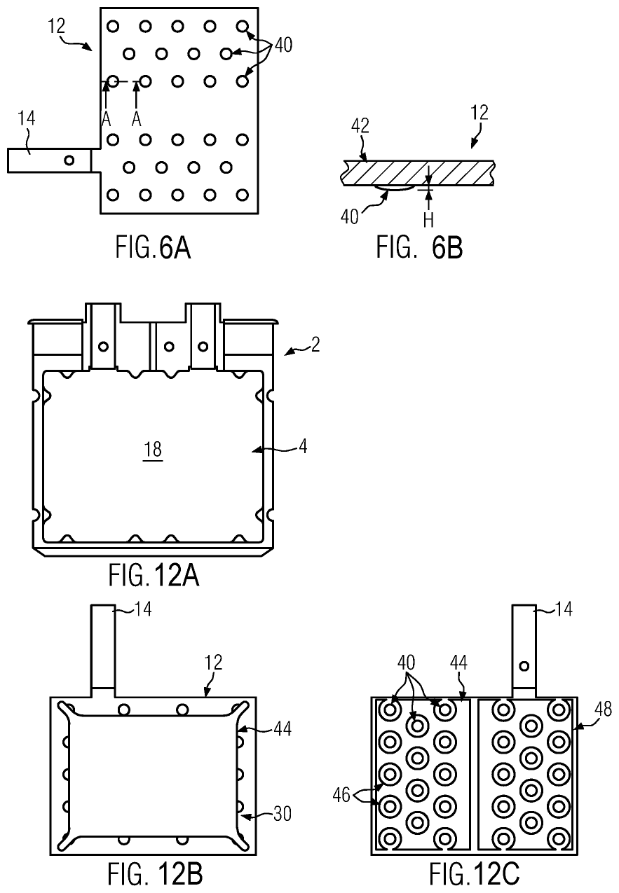

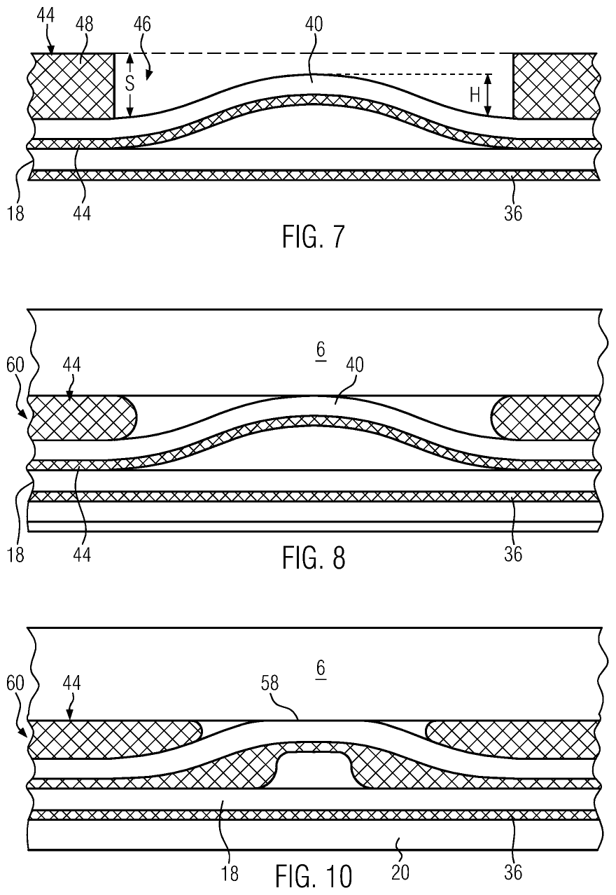

The two contact sheets 12 of the heating cell 19 are provided from one sheet by punching and bending. The basic shape of the respective contact sheets 12 with the terminal lugs 14 is formed by punching. Within the bending process, contact projections characterized by reference sign 40 and shown in FIGS. 6A, 6B, or FIG. 7 are formed by forming. The contact projections 40 are configured as slightly convexly curved elevations. In the embodiment shown, these contact projections 40 have a height H above the plane of sheet metal surface 42 of about 0.1 mm. Within the bending process, the terminal lugs 14 are also bent out of the plane of sheet metal surfaces 42.

The contact sheets 12 thus prepared are provided with an adhesive 44. The adhesive 44 is applied to both main side surfaces of the contact sheets 12. The application to the sheet metal surface 42 overlapped by the contact projections 40 is carried out by screen printing. In the process, recesses 46 are left free around each of the contact projections 40 (see FIG. 12C). The adhesive 44 forms an adhesive layer 48 on this side of the sheet metal surface 42, the thickness S of which is greater than the height H of the contact projections 40 (cf. FIG. 7, 12C). The adhesive 44 provided on the rear side facing away from the contact projections 40 is also applied by screen printing in the form of the previously described adhesive pattern 30 (cf. FIG. 12B).

For assembly, the insulating layer 18 shown in FIG. 1 is first placed on a work surface and the housing 2 is placed on it (cf. FIG. 12A). The accommodation space 4 points upwards. The contact sheet 12 described above, which is coated on both sides with adhesive 44, is inserted into the accommodation space 4 of the housing 2 and bonded to the associated insulating layer 18. As FIGS. 4 and 5 show, the aluminum oxide plate 18 protrudes beyond the legs of the frame-shaped housing 24, whereas the contact sheet 12 is located inside the accommodation space 4. After insertion of the contact sheet 12, the corresponding terminal lug 14 of the contact sheet 12 lies in the connecting piece 16 (cf FIG. 12D).

From the rear side in FIG. 1, the PTC elements 6 are now inserted into the accommodation space 4 (cf. FIG. 12E). Then the further contact plate 12, which is provided with adhesive 44, is mounted and abutted against the PTC elements 6 (cf. FIG. 12F). The cover 17 is mounted (cf. FIG. 12G). In this context, pins of the housing 2 protruding from the housing 2 and penetrating bores in the terminal lugs 14 are guided through associated bores in the cover 17. In order to attach the cover 17, these pins are heat caulked against the cover 17 so that the contact sheets 12 are secured and fixed relative to the housing 2. Then the second aluminum oxide plate 18 is abutted against the contact sheet 12 (cf. FIG. 12H).

Within the assembly process, the individual layers of the heating cell 19 can be pressed against each other to improve the preliminary adhesion of the individual layers of the layered structure via the adhesive 44.

Then, the adhesive pattern 30 is applied to the outer surfaces of the two aluminum oxide plates 18 by means of screen printing (cf. FIG. 12I).

The heating cell thus mounted can still be seen outside the metal housing 20 in FIG. 2.

The heating cell 19 is inserted into the metal housing 20—as shown in FIGS. 3 and 4—until the upper free edge of the metal housing 20 abuts against a collar of the housing 2. This installation position is shown in FIG. 4.

Thereafter, the metal housing 20 is grouted from the outside in a manner to be described so that the inner surfaces 24 of the metal housing 20 are abutted against the aluminum oxide plates 18. The adhesive 36 or 44 is thereby grouted from the central region of the rectangular base area 32 and forced outwardly, namely with a focus over the center of the respective rectangular sides of the rectangular base area 32. In other words, the adhesive is forced outwardly from the rectangular base area 32 between the tip sections 34. This results in full-surface bonding of the inner surfaces 24 of the metal housing 20 over an area corresponding to the projection of the main side surfaces 8 of the PTC elements. The same applies to the adhesive bond between the contact sheet 12 and the associated aluminum oxide plate 18. Thus, good heat extraction is provided by the various layers of the heating cell 19.

FIGS. 7 to 9 illustrate the processes within the heating cell during grouting. In this context, FIG. 7 shows, for example, a cross-section after the front aluminum oxide plate in FIG. 1 has been joined to the front contact sheet 12 in FIG. 1 and to the housing 2. It is evident that the adhesive layer 48 protrudes above the contact projections 40 in the height direction. Each of the contact projections 40 is exposed within the recess 46. The highest point of the contact projection 40 is below the outer surface of the adhesive layer 48. This has a thickness S of between 0.13 and 0.15 mm. Thus, the adhesive layer 48 protrudes by 0.03 to 0.05 mm above the contact projections 40 with a height H of about 0.1 mm. The contact projections 40 are provided in the present case in the form of knobs and have a diameter of about 2 mm. The recesses 46 are circular and have a diameter of 5.0 to 5.5 mm. It is understood that contact projections with other shapes can also be provided instead of knob-shaped ones, for example ribs or webs. It is only important that the shape is appropriate so that the contact projections 40 can be plastically deformed during manufacture and can be abutted against the PTC element 6 without excessively high forming forces having to act externally against the metal housing 20. The shape of the recesses follows the contour of the contact projections.

In FIG. 8, the PTC element 6 is already abutted against the adhesive layer 48 and forced against this adhesive layer, so that the adhesive layer is reduced in height while also being displaced into the recess 46. Excess adhesive material is also displaced into a circumferential gap between the contact sheets 12, the PTC elements 6 on the one hand and the spars of the housing 2 bounding the accommodation space 4. Projections on the inside of the spars keep this gap circumferentially free around the heating cell 19. As a result, the heating cell 19 is circumferentially completely surrounded by the electrically insulating adhesive 44, which abuts internally against the insulating layers. Thus, the components 6, 12 carrying the power current are accommodated in an electrically encapsulated manner in the housing 2, which is particularly preferable when operating the electric heating assembly with high voltage, e.g. in an electrically operated vehicle with the current for the drive thereof, with respect to increasing electrical safety.

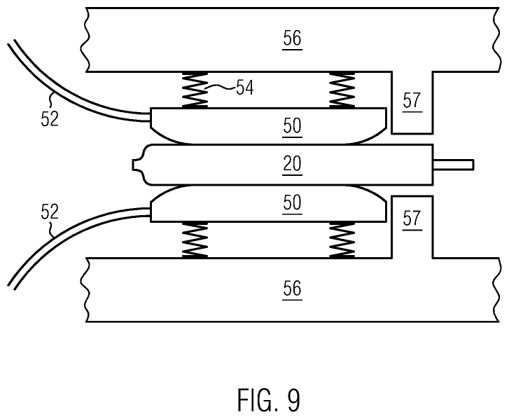

The situation shown in FIG. 8 may occur before the heating cell 19 is inserted into the metal housing 20. However, it can also arise during the forming of the metal housing 20. For this purpose, the metal housing 20 equipped with the heating cell 19 is brought between two tempered punches characterized by reference sign 50 in FIG. 9. The punches 50 are connected via hoses 52 to a circulation with tempered oil, whereby the punches 50 are brought to a temperature of about 180° C. and kept at this temperature.

The tempered punches 50 are supported by springs 54 opposite adjustable retaining plates 56. Press plates 57, which are rigidly connected to the retaining plates 56, protrude in the direction of the metal housing 20. The retaining plates 56 are moved by motor. They can be moved towards and away from each other. Within the scope of this movement, the punches 50 are initially placed against the metal housing 20 on the outside and at the level of the PTC elements 6. A further feed movement of the retaining plates 56 is initially absorbed by compression of the springs 54, which generate a certain contact pressure with which the punches 50 are pressed externally against the metal housing 20. At a sufficient forming force controllable by the spring constant and the spring travel, the metal housing 20 is formed at the level of the PTC elements 6. Within the scope of this forming process, the contact projections 40 are deformed. Within the scope of this forming process, all contact projections 40 are deformed.

As a result, the contact projections 40 are flattened so that they configure deformed flat end regions. Such a deformed end region is characterized by reference sign 58 in FIG. 10. The sheet metal surfaces 42 of the contact sheets 12 are then brought closer to the PTC elements 6.

The press plates 57 act on the metal housing 20 at the level of a sealing area. This sealing area is formed by the widened frame cross member between the accommodation space 4 and the connecting piece 16 protruding therefrom at the upper free end of the housing 2. There, the housing 2 and the cover 17 form a flat cylindrical surface. The press plates 57 are trailing and act against the sealing area. They press the metal housing 20 against the housing 2 as part of the feed movement of the retaining plates 56 and at the end of this feed movement.

As a comparison of FIGS. 8 and 10 illustrates, the adhesive 44 is displaced during deformation of the metal housing 20 at the level of the PTC elements 6 within a free space characterized by reference sign 60 in FIGS. 8 and 10. The height of the free space 60 decreases during deformation. Thus, the adhesive 44 is displaced toward the contact projections 40 as well as toward the outer peripheral surface of the heating cell 19 and into the accommodation space 4. The result at the end of the forming process is a free space 60 the gap height of which is less than the height H of the contact projections 40 in the initial state. The heat conduction path is significantly reduced. By deforming the contact projections, reliable electrical contact is made with the PTC element 6. The adhesive provided on the side of the contact sheets 12 facing away from the PTC element 6 is also subjected to pressure between the insulating layer 18 and the contact sheet 12, with the result that an intimate bond is produced between the contact sheet 12 and the aluminum oxide plate 18 and, in addition, excess adhesive is displaced against the rear side of the contact projections 40 (cf. FIG. 10).

The tempered punches 50 act on the metal housing 20 over a certain time, which is sufficient to cross-link the adhesive 44 as well as the adhesive 36. Thus, direct contact of all layers in the heat conduction path from the PTC elements 6 to the outer surface of the metal housing 20 is assured by bonding. The punches 50 are only moved away from the metal housing 20 after the adhesive 44, 36 has been cross-linked. Thus, the deformation introduced by the punches 50 is secured via the cured adhesive 44 or the adhesive 36.

In the present context, a distinction is made between adhesive 44 and adhesive 36 primarily in terms of terminology. Adhesive 44 and adhesive 36 can be identical substances.

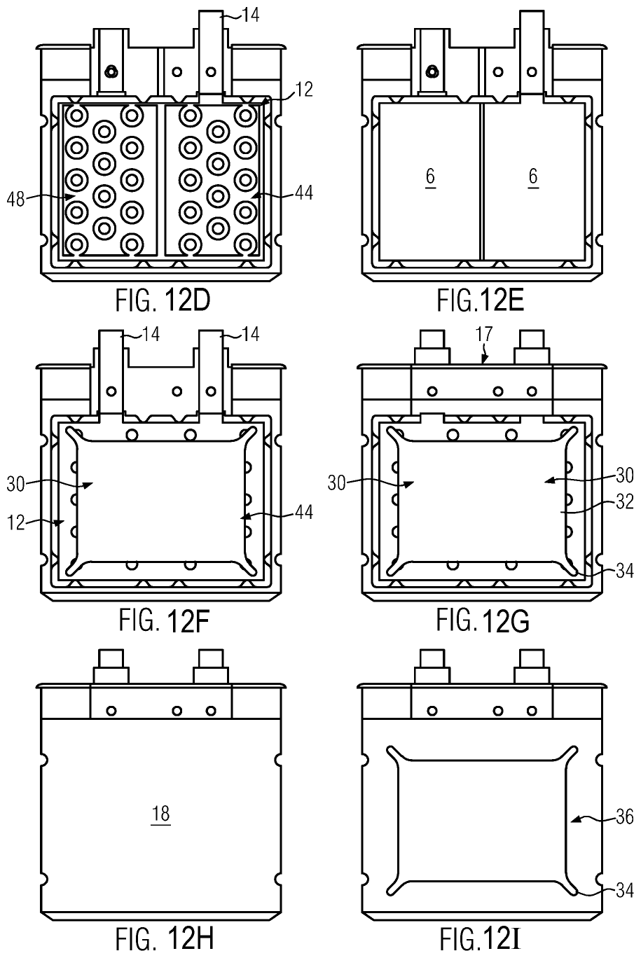

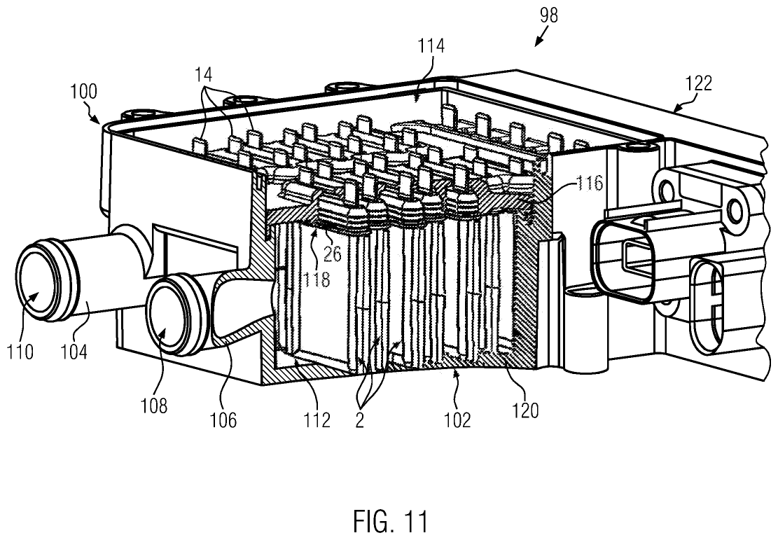

FIG. 11 shows a perspective top view of an electric heating device 98 configured as a water heater with a heater housing 100. The heater housing 100 has a housing tub element 102 made of plastic. The heater housing 100 forms an inlet nozzle 104 and an outlet nozzle 106, which are configured integrally with the housing tub element 102 in the present case. The nozzles 104, 106 are characterized as hose connecting pieces and configure an inlet opening 108 and an outlet opening 110, respectively, to a heating chamber characterized by reference sign 112.

The heating chamber 112 is separated from and sealed with respect to a connection chamber 114 by a plastic partition wall 116. The partition wall 116 configures female plug-in element receptacles 118 for the plurality of electric heating assemblies 28, each of which is sealingly inserted into the female plug-in element receptacles 118 by means of sealing collars 26 connected to the metal housing 20 and supported on a bottom 120 of the housing tub element 102. Reference sign 122 characterizes a control housing, which is described with further details in DE 10 2019 205 848.

The electric heating assemblies 28 according to the invention in connection with such an electric heating device 98 or the examples of electric heating devices discussed in the introduction to the description can also realize the invention. Thereafter, the present invention is also embodied in an electric heating device 98 particularly in a motor vehicle having at least one of the electric heating assemblies 28 according to the invention.

1. An electric heating assembly of an electric heating device comprising:
a metal housing which forms a pocket in which are arranged at least one PTC element, contact sheets that abut surfaces of the PTC element, and insulating layers that are arranged between the contact sheets and inner surfaces of the pocket, wherein the contact sheets each have contact projections which project in a direction of one of the contact surfaces of the PTC element and are surrounded by an adhesive which connects the contact sheet to the PTC element, and wherein
front end regions of the contact projections abut against the PTC element and are plastically deformed against the surfaces of the PTC element.

2. The electric heating assembly according to claim 1, wherein the front end regions of the contact projections are plastically deformed against the surfaces of the PTC element with displacement of the adhesive.

3. The electric heating assembly according to claim 1, wherein the electric heating assembly is configured for use in a vehicle.

4. A method of manufacturing an electric heating assembly having a metal housing forming a pocket in which are arranged at least one PTC element, contact sheets that abut surfaces of the PTC element, and insulating layers that are arranged between the contact sheets and inner surfaces of the pocket, wherein the contact sheets each have contact projections which project in a direction of a main side surface of the PTC element and which are surrounded by an adhesive which connects the contact sheets in each case to the PTC element, the method comprising:
providing the metal housing such that the contact projections are plastically deformed;
providing the contact sheets with an initially flat sheet metal surface that is machined to form the contact projections protruding from the sheet metal surface,
applying the adhesive to the strip conductors without the contact projections being covered with the adhesive; and
introducing, into the pocket of the metal housing, the strip conductors in abutment against the PTC element with inclusion of the adhesive and with the insulating layers abutting externally against the strip conductors.

5. The method according to claim 4, wherein the adhesive is applied to the contact sheet with a thickness greater than a height of the contact projections.

6. The method according to claim 4, wherein the contact projections are formed as convexly curved elevations on the initially flat sheet metal surface of the contact sheets.

7. The method according to claim 4, wherein, before insertion into the pocket, the insulating layer is provided on an outside and/or a rear side of the contact sheets facing away from the contact projections with an adhesive pattern which has a substantially rectangular base area and tip sections projecting from the base area at corners thereof.

8. The method according to claim 4, wherein the contact projections are formed as convexly curved elevations with a height of between 0.09 mm and 0.12 mm above the flat sheet metal surface.

9. The method according to claim 4, wherein the metal housing is deformed with a tempered punch, and wherein the adhesive is a cross-linking silicone adhesive which is cross-linked via heat introduced by way of the tempered punch.

10. The method according to claim 9, wherein the metal housing is deformed between two tempered punches, each of which is supported by springs relative to a movable retaining plate.
